(19) United States
(12) Patent Application Publication
(10) Pub. No.: US 2025/0133610 A1
(43) Pub. Date: Apr. 24, 2025

(54) INTELLIGENT RIDER INTERFACE FOR CONNECTING MULTIPLE WIRELESS DEVICES FOR FULL DUPLEX VOICE COMMUNICATION OVER A WIRELESS NETWORK

(71) Applicant: BITwave Pte Ltd., Singapore (SG)

(72) Inventors: Siew Kok HUI, Singapore (SG); Eng Sui TAN, Singapore (SG); Wanqiao SHI, Singapore (SG); Lew Qing XIANG, Singapore (SG)

(21) Appl. No.: 18/817,777

(22) Filed: Aug. 28, 2024

Related U.S. Application Data
(60) Provisional application No. 63/592,055, filed on Oct. 20, 2023.

(51) Int. Cl. H04W 76/11; G06K 19/06

(52) U.S. Cl. CPC H04W 76/11; G06K 19/06037

(57) ABSTRACT

Connecting multiple wireless devices for full duplex voice communication over a wireless network (e.g., using a computerized tool), is enabled. For example, a system can comprise a first mobile device comprising a mobile application installed and executing thereon, at least one processor, and at least one memory that stores executable instructions that, when executed by the at least one processor, facilitate performance of operations. The operations can comprise scanning an identifier displayed via a second mobile device, other than the first mobile device, wherein the first mobile device is communicatively coupled to a first wireless device registered with the first mobile device, and wherein the identifier is representative of a second wireless device communicatively coupled to the second mobile device and registered with the second mobile device, and using the identifier, wirelessly connecting the first wireless device to the second wireless device.

### CROSS-REFERENCE TO RELATED APPLICATION

This application claims the benefit of U.S. Provisional Patent Application No. 63/592,055, filed Oct. 20, 2023, and entitled “AN INTELLIGENT METHOD AND RIDER INTERFACE FOR CONNECTING MULTIPLE WIRELESS DEVICES FOR FULL DUPLEX VOICE COMMUNICATION OVER A WIRELESS NETWORK,” which priority application is incorporated by reference herein in its entirety.

### BACKGROUND

Riders of powersports vehicles, such as motorcycles, snowmobiles, personal watercraft (PWC), all-terrain vehicles (ATVs), utility task vehicles (UTVs), side-by-sides, dirt bikes, scooters, mopeds, off-road vehicles, airplanes, etc., often travel in groups. To stay in communication, riders of these vehicles often utilize helmet-mounted communicators. However, establishing a wireless connection between such communicators can be time consuming and cumbersome, especially as the number of riders in a group of riders grows.

The above-described background relating to wireless communicators is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of a non-limiting example system in accordance with one or more example embodiments described herein.

FIG. 2 is a block diagram of a non-limiting computer executable components in accordance with one or more example embodiments described herein.

FIG. 3 is a diagram of a non-limiting device pairing in accordance with one or more example embodiments described herein.

FIG. 4 is a diagram of a non-limiting device pairing in accordance with one or more example embodiments described herein.

FIG. 5 is a flowchart for a process associated with connecting multiple wireless devices for full duplex voice communication over a wireless network in accordance with one or more example embodiments described herein.

FIG. 6 is a diagram of a non-limiting device pairing in accordance with one or more example embodiments described herein.

FIG. 7 is a flowchart for a process associated with connecting multiple wireless devices for full duplex voice communication over a wireless network in accordance with one or more example embodiments described herein.

FIG. 8 is a block flow diagram for a process associated with connecting multiple wireless devices for full duplex voice communication over a wireless network in accordance with one or more example embodiments described herein.

FIG. 9 is a block flow diagram for a process associated with connecting multiple wireless devices for full duplex voice communication over a wireless network in accordance with one or more example embodiments described herein.

FIG. 10 is a block flow diagram for a process associated with connecting multiple wireless devices for full duplex voice communication over a wireless network in accordance with one or more example embodiments described herein.

FIG. 11 is an example, non-limiting computing environment in which one or more embodiments described herein can be implemented.

FIG. 12 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, communicator pairing can be improved in various ways, and various embodiments are described herein to this end and/or other ends. The disclosed subject matter relates to communicator pairing and, more particularly, to connecting multiple wireless devices for full duplex voice communication over a wireless network.

In order for riders, of a group of riders, to have full duplex wireless voice communication using their wireless device (WD) (e.g., a helmet communicator), all riders of the group must pair their respective WDs. An ad hoc wireless network, such as mesh network based on Bluetooth, ZigBee, or other suitable wireless technology types, can be utilized. Such an ad hoc network can be easily established, especially when a normal mobile network (e.g., long term evolution (LTE), fourth generation (4G), fifth generation (5G), sixth generation (6G), etc.) is not available, and enables full duplex voice communication over many devices, while facilitating overall mobility. Thus, such WDs can be utilized even when cellular coverage is not available.

Example conventional WD pairing (e.g., of a group of four WDs) can occur according to the following steps:
1. Power on a WD by pressing the power button of the device.
2. Press the pairing button of the WD.
3. An LED light will start flashing purple color.
4. Any rider can press the power button again to start the pairing process.
5. Only one rider is permitted to start the process by pressing the power button.
6. Once a rider presses the power button, the pairing process will start, and all four WDs will be paid.
7. If the pairing process succeeds, the WD will display a flashing green LED light, for example.
8. The pairing process will end after a pre-set time limit, for example, after 15 seconds if no new WD is found.

The above button method, however, is a complicated process for riders. Using the above conventional pairing method, a rider must remember a button sequence and correctly follow through until the end of the pairing sequence. If the pairing were to fail, for example, due to the poor contact of the button or for another reason, the process would have to be restarted.

Embodiments herein integrate a WD, such as a helmet communicator, with a mobile application running on a mobile device (e.g., a smartphone, smartwatch, tablet, or another suitable mobile device) that can generate a quick-response (QR) code unique to the WD such as the media access control (MAC) address of the WD. In this regard, the mobile device is paired to (e.g., registered with) the WD. Thus, mobile devices herein can facilitate pairing between WDs, thus establishing direct connections between corresponding WDs.

In a nonlimiting example embodiment, assume, for instance, four riders (e.g., Rider 1, Rider 2, Rider 3, and Rider 4) along with four respective WDs (WD 1, WD 2, WD 3, and WD 4). Embodiments herein enable pairing of the four WDs, with each other, for full duplex wireless voice communication, for instance, via a QR code pairing method using their corresponding, paired, mobile devices. It is noted that embodiments herein enable multiple QR code pairing processes.

According to an example embodiment, a system can comprise a first mobile device comprising a mobile application installed and executing thereon, at least one processor, and at least one memory that stores executable instructions that, when executed by the at least one processor, facilitate performance of operations, comprising scanning an identifier displayed via a second mobile device, other than the first mobile device, wherein the first mobile device is communicatively coupled to a first wireless device registered with the first mobile device, and wherein the identifier is representative of a second wireless device communicatively coupled to the second mobile device and registered with the second mobile device, and using the identifier, wirelessly connecting the first wireless device to the second wireless device.

In one or more example embodiments, the identifier can comprise a first identifier, and the above operations can further comprise scanning a second identifier displayed via a third mobile device, other than the first mobile device and other than the second mobile device, wherein the second identifier is representative of a third wireless device communicatively coupled to the third mobile device and registered with the third mobile device, and using the second identifier, wirelessly connecting the third wireless device to the second wireless device and to the first wireless device. In this regard, the wirelessly connecting of the third wireless device to the second wireless device and to the first wireless device can be performed in response to a determination that no additional wireless devices other than the second wireless device and the third wireless device are to be connected.

In one or more example embodiments, the wirelessly connecting of the second wireless device to the first wireless device can be performed in response to a determination that no additional wireless devices other than the second wireless device are to be wirelessly connected.

In one or more example embodiments, the first wireless device can comprise a wireless voice communication device. In this regard, the wireless voice communication device can comprise a helmet communicator configured to transmit, receive, record, and render voice and sound signals.

In one or more example embodiments, the identifier can be representative of a medium access control (MAC) address of the second wireless device.

In one or more example embodiments, the identifier can comprise a quick response (QR) code.

In one or more example embodiments, the first wireless device and the second wireless device can be among a group of wireless devices to be wirelessly connected to each other via the first mobile device.

In one or more example embodiments, the wirelessly connecting of the second wireless device to the first wireless device can be performed in response to receiving an instruction to wirelessly connect the second wireless device to the first wireless device.

In another example embodiment, a non-transitory machine-readable medium can comprise executable instructions that, when executed by a processor, facilitate performance of operations, comprising capturing an identifier displayed via a second mobile device, other than a first mobile device, wherein the first mobile device is communicatively coupled to a first wireless device registered with the first mobile device, and wherein the identifier is representative of a second wireless device communicatively coupled to the second mobile device and registered with the second mobile device, and using the identifier, communicatively coupling the first wireless device to the second wireless device.

In one or more example embodiments, the communicatively coupling of the second wireless device to the first wireless device can be performed in response to the capturing of the identifier displayed via the second mobile device.

In one or more example embodiments, the above operations can further comprise capturing another identifier, other than the identifier, displayed via a third mobile device, other than the first mobile device and other than the second mobile device, wherein the other identifier is representative of a third wireless device communicatively coupled to the third mobile device and registered with the third mobile device, and using the other identifier, communicatively coupling the third wireless device to the second wireless device and to the first wireless device. In this regard, the communicatively coupling of the third wireless device to the first wireless device and to the second wireless device can be performed in response to the capturing of the identifier displayed via the third mobile device.

In one or more example embodiments, the first wireless device can comprise a wireless voice communication device. In this regard, the wireless voice communication device can comprise a helmet communicator.

In one or more example embodiments, the identifier can be representative of a medium access control (MAC) address of the second wireless device.

In yet another example embodiment, a method can comprise scanning, by a first mobile device comprising at least one processor, an identifier displayed on a second mobile device, other than the first mobile device, wherein the first mobile device is communicatively coupled to a first wireless device registered with the first mobile device, and wherein the identifier is representative of a second wireless device communicatively coupled to the second mobile device and registered with the second mobile device, and based at least in part on the identifier, connecting, by the first mobile device, the first wireless device to the second wireless device.

In one or more example embodiments, the identifier can comprise a quick response (QR) code.

In one or more example embodiments, the first wireless device and the second wireless device can be among a group of wireless devices designated to be communicatively coupled to each other via the first mobile device.

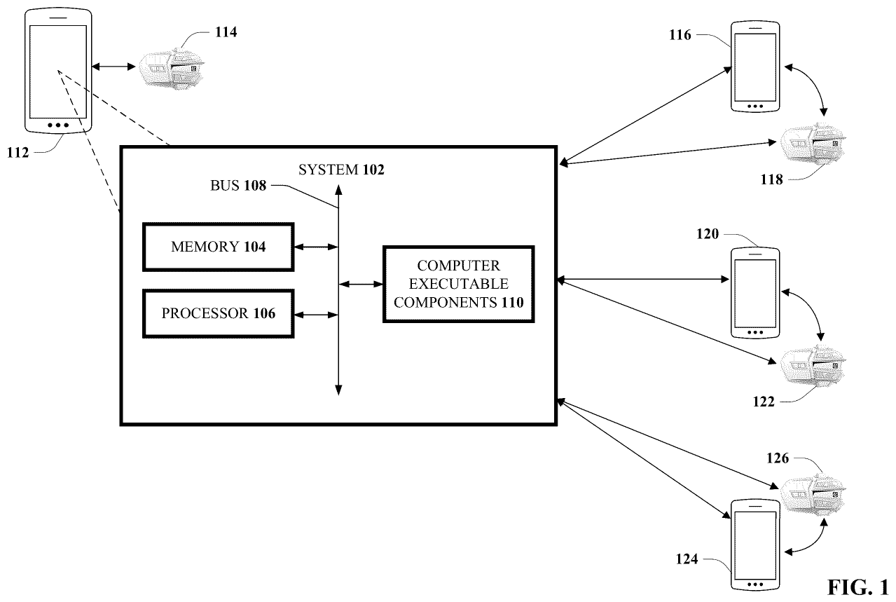

Turning now to FIG. 1, there is illustrated an example, non-limiting system 102 in accordance with one or more example embodiments herein. System 102 can comprise a computerized tool, which can be configured to perform various operations relating to connecting multiple wireless devices for full duplex voice communication over a wireless network. The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102. In various embodiments, a mobile device 112 (e.g., and/or another mobile device such as mobile device 116, mobile device 120, mobile device 124, and/or another suitable mobile device) can comprise the system 102. In various embodiments, the mobile device 112 (e.g., a first mobile device) can be paired (e.g., communicatively coupled) with WD 114 (e.g., WD 1). In various embodiments, the mobile device 112 can be communicatively coupled with mobile device 116 (e.g., a second mobile device, mobile device 120 (e.g., a third mobile device, and/or mobile device 124 (e.g., a fourth mobile device) (e.g., over a wireless network). In various embodiments, the mobile device 116 can be paired (e.g., communicatively coupled) with WD 118 (e.g., WD 2). In various embodiments, the mobile device 120 can be paired (e.g., communicatively coupled) with WD 122 (e.g., WD 3). In various embodiments, the mobile device 124 can be paired (e.g., communicatively coupled) with WD 126 (e.g., WD 4). Pairing between mobile devices and WDs herein can be performed, for instance, using one or more of a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.)

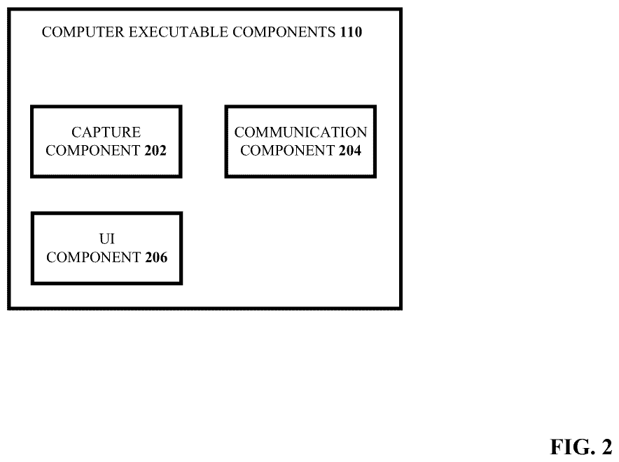

FIG. 2 illustrates a block diagram of example, non-limiting computer executable components 110 that can facilitate connecting multiple wireless devices for full duplex voice communication over a wireless network in accordance with one or more embodiments described herein. Repetitive description of like elements employed in other embodiments described herein is omitted for sake of brevity. As shown in FIG. 2, the one or more computer executable components 110 can comprise capture component 202, communication component 204, and/or user interface (UI) component 206.

In various embodiments, the capture component 202 can scan an identifier displayed via a second mobile device (e.g., mobile device 116), other than a first mobile device (e.g., mobile device 112). In various embodiments, the identifier can be representative of a medium access control (MAC) address of a second wireless device (e.g., WD 118) or another suitable identifier (e.g., a unique identifier) associated with the second wireless device (e.g., WD 118). It is noted that, in various embodiments, the identifier can comprise a quick response (QR) code (e.g., QR code 302). In various embodiments, the capture component 202 can utilize a camera of a respective mobile device (e.g., mobile device 112 or another mobile device herein) in order to locate, decode, and extract data from the scanned QR code (e.g., QR code 302). In various embodiments, the QR code 302 can comprise pairing information in order to pair WDs herein. For instance, the QR code 302 can comprise a MAC address associated with a WD herein. It is noted that, in various embodiments herein, the first mobile device (e.g., mobile device 112) can be communicatively (e.g., wirelessly) coupled to a first wireless device (e.g., WD 114) registered with the first mobile device (e.g., mobile device 112), and that the identifier can be representative of a second wireless device (e.g., WD 118) communicatively coupled to the second mobile device (e.g., mobile device 116) and registered with the second mobile device (e.g., mobile device 116). In various embodiments, the first wireless device (e.g., WD 114) can comprise a wireless voice communication device. In this regard, the wireless voice communication device can comprise a helmet communicator configured to transmit, receive, record, and render voice and sound signals. In various embodiments, the first wireless device (e.g., WD 114) and the second wireless device (e.g., WD 118) can be among a group of wireless devices (e.g., WD 114, WD 118, WD 122, and/or WD 126) to be wirelessly connected to each other via the first mobile device (e.g., mobile device 112). It is noted, however, that any suitable quantity of WDs can be paired, and embodiments herein are not limited to four WDs or another quantity of WDs.

In various embodiments, the communication component 204 can, using the identifier, wirelessly connect the first wireless device (e.g., WD 114) to the second wireless device (e.g., WD 118). WDs herein can be paired (e.g., to one another and/or to respective mobile devices herein) using one or more of a variety of wireless communication protocols. For instance, the communication component 204 can pair WDs herein using one or more of Bluetooth, ZigBee, e.g., infrared (“IR”), shortwave transmission, near-field communication (“NFC”), Wi-Fi, long-term evolution (“LTE”), 3G, 4G, 5G, 6G, global system for mobile communications (“GSM”), code-division multiple access (“CDMA”), satellite, visual cues, radio waves, etc. It is noted that the communication component 204 can comprise the hardware required to implement a variety of communication such protocols (e.g., IR, shortwave transmission, NFC, Bluetooth, ZigBee, Wi-Fi, LTE, 3G, 4G, 5G, 6G, GSM, CDMA, satellite, visual cues, radio waves, etc.). In various embodiments, pairing between mobile devices herein and WDs herein can also occur according to one or more of the described communication protocols (e.g., IR, shortwave transmission, NFC, Bluetooth, ZigBee, Wi-Fi, LTE, 3G, 4G, 5G, 6G, GSM, CDMA, satellite, visual cues, radio waves, etc.). Generally, pairing between mobile devices herein and WDs herein can precede pairing between WDs herein, but embodiments herein are not so limited. All possible pairing sequences are envisaged. For instance, corresponding pairs of mobile devices and WDs herein can be paired (e.g., via the communication components 204 of respective mobile devices herein), and then the mobile devices can be utilized (e.g., via communication components 204 of respective mobile devices herein) to scan QR codes herein in order to link WDs herein via direct connections, thus eliminating the need for users of WDs herein to directly interface with WDs herein to pair WDs to one another. The foregoing significantly improves speed, usability, and reliability of communicator device pairing herein.

In various embodiments, the above-noted identifier can comprise a first identifier. In this regard, the capture component 202 can scan a second identifier displayed (e.g., using a respective UI component 206) via a third mobile device (e.g., mobile device 120), other than the first mobile device (e.g., mobile device 112) and other than the second mobile device (e.g., mobile device 116). In various embodiments, the second identifier can be representative of a third wireless device (e.g., WD 122) communicatively coupled to the third mobile device (e.g., mobile device 120) and registered with the third mobile device (e.g., mobile device 120). The communication component 204 can then, using the second identifier, wirelessly connect the third wireless device (e.g., WD 122) to the second wireless device (e.g., WD 118) and to the first wireless device (e.g., WD 114). In this regard, the wirelessly connecting of the third wireless device (e.g., WD 122) to the second wireless device (e.g., WD 118) and to the first wireless device (e.g., WD 114) can be performed (e.g., via the communication component 204) in response to a determination (e.g., via the communication component 204, the capture component 202, and/or the UI component 206) that no additional wireless devices other than the second wireless device (e.g., WD 118) and the third wireless device (e.g., WD 122) are to be connected (e.g., via the communication component 204). In an embodiment, such a determination that no additional wireless devices other than the second wireless device (e.g., WD 118) and the third wireless device (e.g., WD 122) are to be connected can be made in response to selection of a connect button 406 (e.g., via the UI component 206).

In various embodiments, the wirelessly connecting of the second wireless device (e.g., WD 118) to the first wireless device (e.g., WD 114) can be performed (e.g., via the communication component 204) in response to a determination (e.g., via the communication component 204, the capture component 202, and/or the UI component 206) that no additional WDs (e.g., other than the WD 118) are to be wirelessly connected. In an embodiment, such a determination that no additional wireless devices other than the second wireless device (e.g., WD 118) and the third wireless device (e.g., WD 122) are to be connected can be made in response to selection of a connect button 406 (e.g., via the UI component 206). In this regard, a connection between the WD 114 and the WD 118 can be established (e.g., via the communication component 204). In various embodiments, the wirelessly connecting (e.g., via the communication component 204) of the WD 118 to the WD 114 can be performed in response to receiving an instruction to wirelessly connect the WD 118 to the WD 114. Such an instruction can be received, for instance, by a selection (e.g., via a UI component 206) of a scan button 304 on a mobile device herein. In various embodiments, the system 102 can determine that no additional WDs are to be wirelessly connected in response to selection (e.g., via a UI component 206) of a connect button 406 on a mobile device herein. It is noted that the UI component 206 can utilize buttons (e.g., virtual and/or physical) and/or touch screen(s) of a corresponding mobile device herein in order to facilitate user interaction with the respective mobile device herein.

In another embodiment, the capture component 202 can capture an identifier (e.g., a QR code) displayed via a second mobile device (e.g., mobile device 116), other than a first mobile device (e.g., mobile device 112). In this regard, the first mobile device (e.g., mobile device 112) can be communicatively coupled to a first wireless device (e.g., WD 114) registered with the first mobile device (e.g., mobile device 112), and the identifier can be representative of a second wireless device (e.g., WD 118) communicatively coupled to the second mobile device (e.g., mobile device 116) and registered with the second mobile device (e.g., mobile device 116). The communication component 204 can then, using the identifier, communicatively couple the first wireless (e.g., WD 114) device to the second wireless device (e.g., WD 118). It is noted that the communicatively coupling of the second wireless device (e.g., WD 118) to the first wireless device (e.g., WD 114) can be performed (e.g., via the communication component 204) in response to the capturing (e.g., via the capture component 202) of the identifier displayed via the second mobile device (e.g., mobile device 116). In this regard, selection of the connect button 406 is not needed, as the connection between the WDs can be automatically established (e.g., via the communication component 204) upon the scanning (e.g., via the capture component 202) of the respective identifiers (e.g., QR codes).

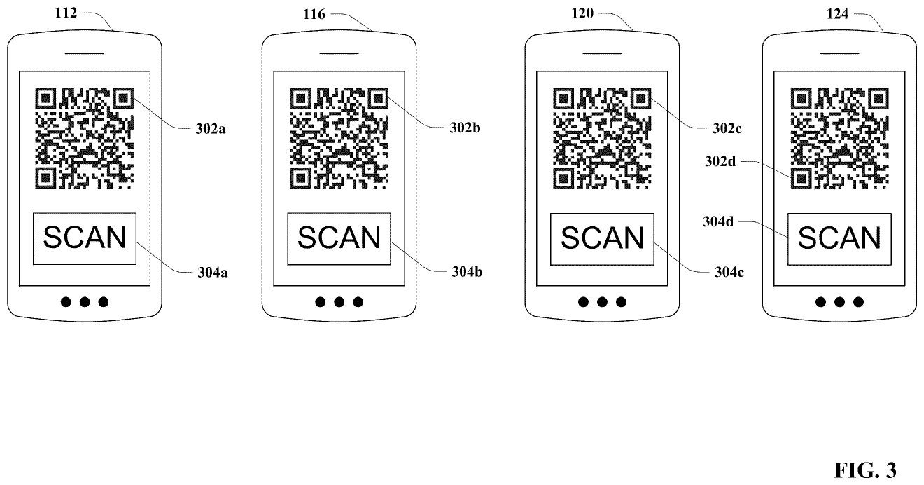

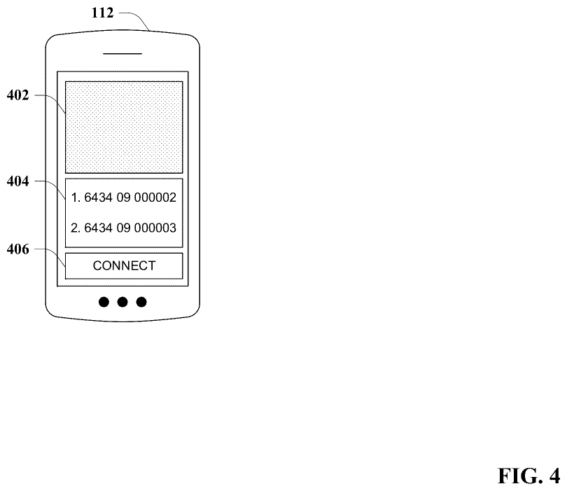

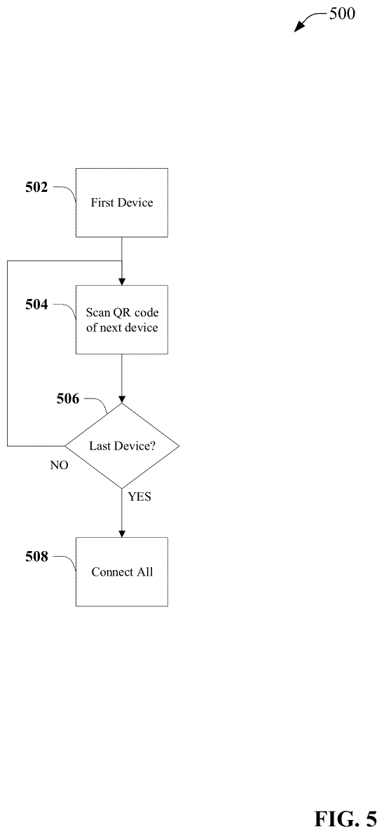

FIG. 3 is a diagram of a non-limiting device pairing in accordance with one or more example embodiments described herein. In FIG. 3, a mobile device herein (e.g., mobile device 112, mobile device 116, mobile device 120, mobile device 124, etc.) can display (e.g., via the UI component 206) a respective scan button 304 and/or a respective QR code 302 associated with its respective WD. It is noted that the scan button 304 and/or the QR code 302 can comprise respective elements of a mobile application executing on the mobile device 112, or can comprise physical buttons (e.g., tactile buttons), capacitive buttons, virtual buttons, or other suitable button types of the mobile device 112. In this example, the mobile device 112 can initiate a scanning mode by determining (e.g., via the UI component 206) an occurrence of a selection of the scan button 304. Upon selection of the scan button 304, the mobile device 112 can appear as shown in FIG. 4 (e.g., with a corresponding UI generated via the UI component 206). In this regard, a new page (e.g., UI) can be generated (e.g., via the UI component 206) with a QR code scanning window 402, as shown in FIG. 4. A camera (e.g., camera sensor) of the mobile device 112 can be utilized (e.g., via the capture component 202) to scan a QR code 302 of another mobile device herein (e.g., other than the mobile device 112). When the QR code 302 is captured (e.g., via capture component 202), a window 404 can be populated (e.g., via the UI component 206) with the MAC address of the WD associated with the QR codes scanned via the mobile device 112. In various embodiments, a MAC address herein can be registered with a username, enabling the window 404 to be populated (e.g., via the UI component 206) with usernames and/or other identifiers, other than MAC addresses. In various embodiments, the mobile device 112 can continue to scan (e.g., via the capture component 202) identifiers (e.g., QR codes) herein until the window 404 is populated with all devices intended to be paired (e.g., via the mobile device 112). After the QR code 302 is scanned, the connect button 406 can be determined (e.g., via the UI component 206) to be selected, which can initiate the establishment (e.g., via the communication component 204) of an intercom group connection of all the WDs populated in the window 404. A flowchart of the foregoing is provided in FIG. 5.

FIG. 5 is a flowchart for a process 500 associated with connecting multiple wireless devices for full duplex voice communication over a wireless network in accordance with one or more example embodiments described herein. At 502, a first device can be established. The first device can comprise, for instance, a first mobile device (e.g., mobile device 112) or a first wireless device (e.g., WD 114) associated with the first mobile device (e.g., mobile device 112). In various embodiments, the first mobile device to initiate (e.g., via the system 102) pairing can become the first mobile device by default. In various embodiments, the first device herein can be established by selection (e.g., via the UI component 206) of the scan button 304 of a mobile device herein. At 504, a QR code 302 of a next device herein (e.g., a second mobile device) can be scanned (e.g., via the capture component 202). At 506, if the last device (e.g., mobile device) has not been scanned (e.g., via the capture component 202) (e.g., NO at 506), the process can return to 504. If at 506, the last device (e.g., mobile device) has been scanned (e.g., via the capture component 202) (e.g., YES at 506), the process can proceed to 508. At 508, all WDs associated with scanned QR codes herein can be paired (e.g., via the communication component 204) for an intercom connection herein.

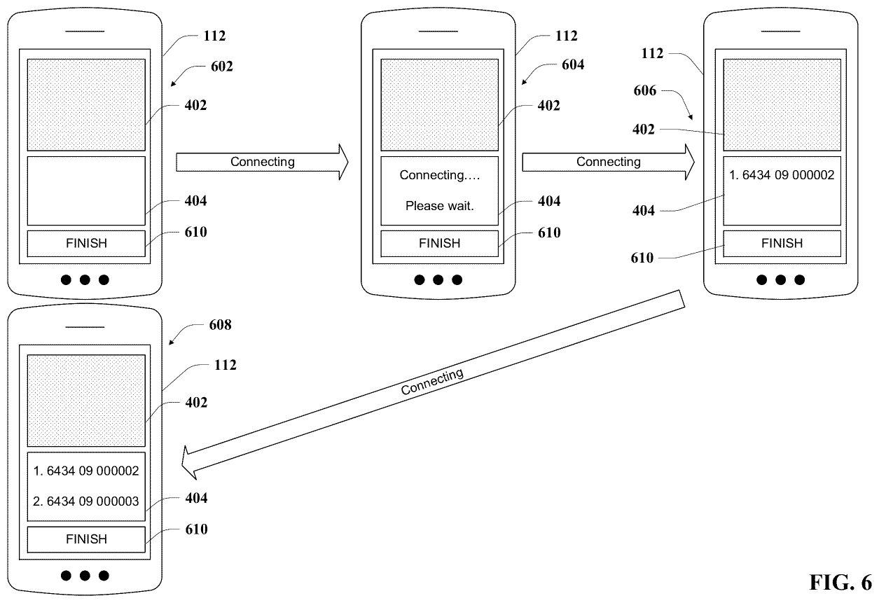

FIG. 6 is a diagram of a non-limiting device pairing in accordance with one or more example embodiments described herein. In FIG. 6, device pairing herein differs from FIG. 4 in that in that pairing (e.g., via the communication component 204) with respect to FIG. 6 occurs as each mobile device herein is scanned, rather than all at once at the end of scanning (e.g., as in FIG. 4). In FIG. 6, at 602, the mobile device 112 can display (e.g., via UI component 206) a scanning window 402, a window 404, and a finish button 610 (e.g., via a mobile application executing on the mobile device 112). In this example, the mobile device 112 can initiate a scanning mode in response to selection (e.g., via the UI component 206) of the scan button 304. Upon selection (e.g., via the UI component 206) of the scan button 304, the mobile device 112 can appear (e.g., via the UI component 206) as shown in FIG. 6. In this regard, a new page (e.g., UI) can be generated (e.g., via the UI component 206) with an identifier (e.g., QR code) scanning window 402, as shown in FIG. 6. In various embodiments, a camera (e.g., camera sensor) of the mobile device 112 can be utilized to scan (e.g., via the capture component 202) a QR code 302 of another mobile device herein (e.g., other than the mobile device 112). When the QR code 302 is captured (e.g., via the capture component 202), a window 404 can be populated (e.g., via the UI component 206) with the MAC address of the WD associated with the QR codes scanned via the mobile device 112. In various embodiments, a MAC address herein can be registered with a username, enabling the window 404 to be populated with usernames and/or other identifiers, other than MAC addresses. In various embodiments, the mobile device 112 can continue to scan QR codes herein until the window 404 is populated with all devices intended to be paired. After the QR code 302 is scanned, the WD associated with the scanned QR code 302 can be immediately connected to the WD paired with the mobile device 112 and/or added to the intercom connection including the WD paired with the mobile device 112. If the QR code 302 is successfully captured (e.g., via the capture component 202), the mobile device 112 can immediately attempt to establish (e.g., via the communication component 204) a connection to the WD associated with the scanned identifier (e.g., QR code). At 604, the UI component can generate a message (e.g., in the window 404) that that the mobile device 112 is connecting WDs herein (e.g., in an intercom connection via the communication component 204). At 606 and 608, after successful connection (e.g., via the communication component 204), the WD(s) (e.g., identifiers applicable to the WD(s)) can displayed (e.g., via the UI component 206) on the connected device list in the window 404, as shown in FIG. 6.

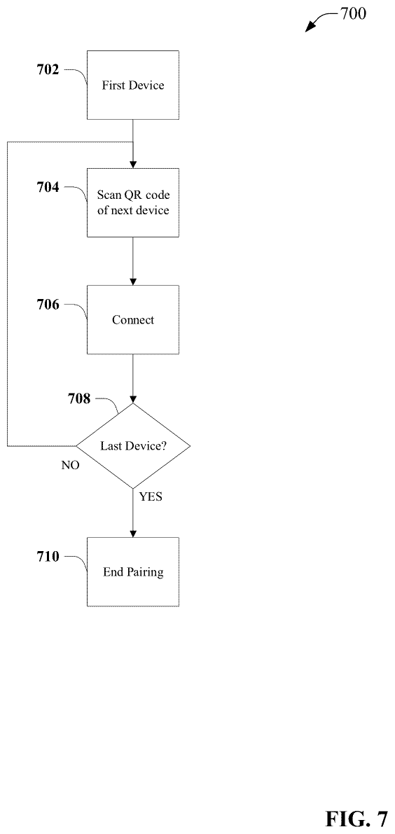

FIG. 7 is a flowchart for a process 700 associated with connecting multiple wireless devices for full duplex voice communication over a wireless network in accordance with one or more example embodiments described herein. At 702, a first device can be established. The first device (e.g., mobile device) can comprise a first mobile device (e.g., mobile device 112) or a first wireless device (e.g., WD 114) associated with a first mobile device (e.g., mobile device 112). In various embodiments, the first mobile device to initiate (e.g., via the system 102) pairing can become the first mobile device by default. In various embodiments, the first device (e.g., mobile device) can be established by selection (e.g., via the UI component 206) of the scan button 304 of a mobile device herein. At 704, a QR code 302 of a next device (e.g., mobile device) herein can be scanned (e.g., via the capture component 202). At 706, a WD associated with the respective scanned QR code 302 can be immediately paired (e.g., via the communication component 204) for an intercom connection herein. At 708, if the last device (e.g., mobile device) has not been scanned (e.g., via the capture component 202) (e.g., NO at 708), the process can return to 704. If at 708, the last device (e.g., mobile device) has been scanned (e.g., via the capture component 202) (e.g., YES at 708), the process can proceed to 710. At 710, pairing can be ended (e.g., via the communication component 204).

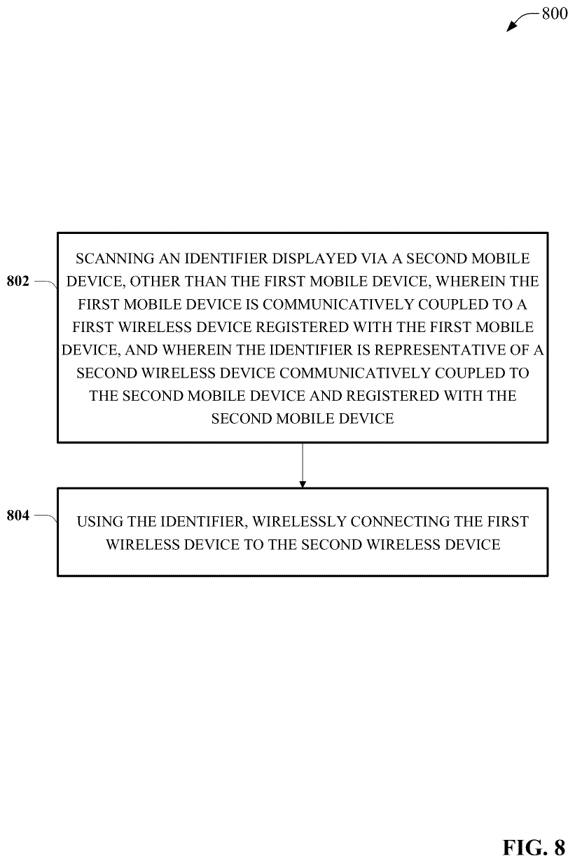

FIG. 8 illustrates a block flow diagram for a process 800 associated with connecting multiple wireless devices for full duplex voice communication over a wireless network in accordance with one or more embodiments described herein. At 802, the process 800 can comprise scanning (e.g., via a capture component 202) an identifier displayed via a second mobile device (e.g., mobile device 116), other than a first mobile device (e.g., mobile device 112), wherein the first mobile device (e.g., mobile device 112) is communicatively coupled to a first wireless device (e.g., WD 114) registered with the first mobile device (e.g., mobile device 112), and wherein the identifier is representative of a second wireless device (e.g., WD 118) communicatively coupled to the second mobile device (e.g., mobile device 116) and registered with the second mobile device (e.g., mobile device 116). At 804, the process 800 can comprise, using the identifier, wirelessly connecting (e.g., via the communication component 204) the first wireless device (e.g., WD 114) to the second wireless device (e.g., WD 118).

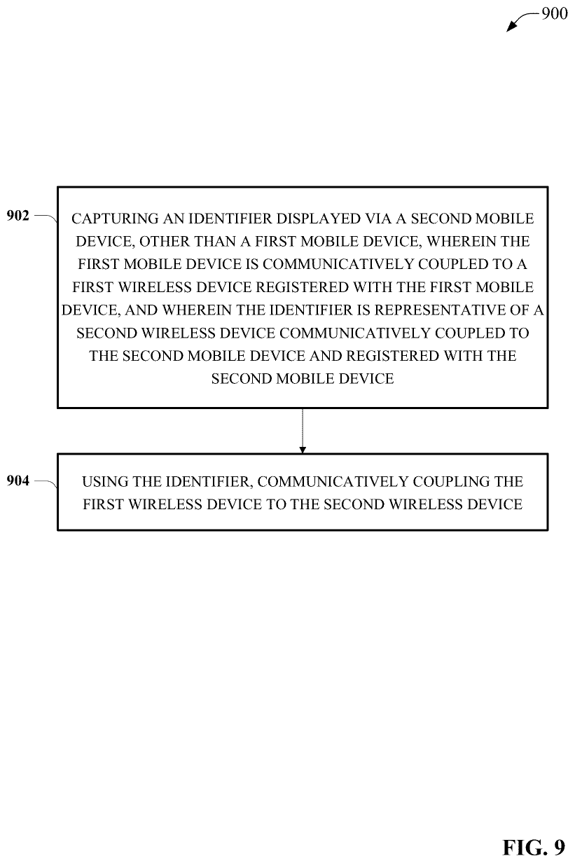

FIG. 9 illustrates a block flow diagram for a process 900 associated with connecting multiple wireless devices for full duplex voice communication over a wireless network in accordance with one or more embodiments described herein. At 902, the process 900 can comprise capturing (e.g., via the capture component 202) an identifier displayed via a second mobile device (e.g., mobile device 116), other than a first mobile device (e.g., mobile device 112), wherein the first mobile device (e.g., mobile device 112) is communicatively coupled to a first wireless device (e.g., WD 114) registered with the first mobile device (e.g., mobile device 112), and wherein the identifier is representative of a second wireless device (e.g., WD 118) communicatively coupled to the second mobile device (e.g., mobile device 116) and registered with the second mobile device (e.g., mobile device 116). At 904, the process 900 can comprise, using the identifier, communicatively coupling (e.g., via the communication component 204) the first wireless device (e.g., WD 114) to the second wireless device (e.g., WD 118).

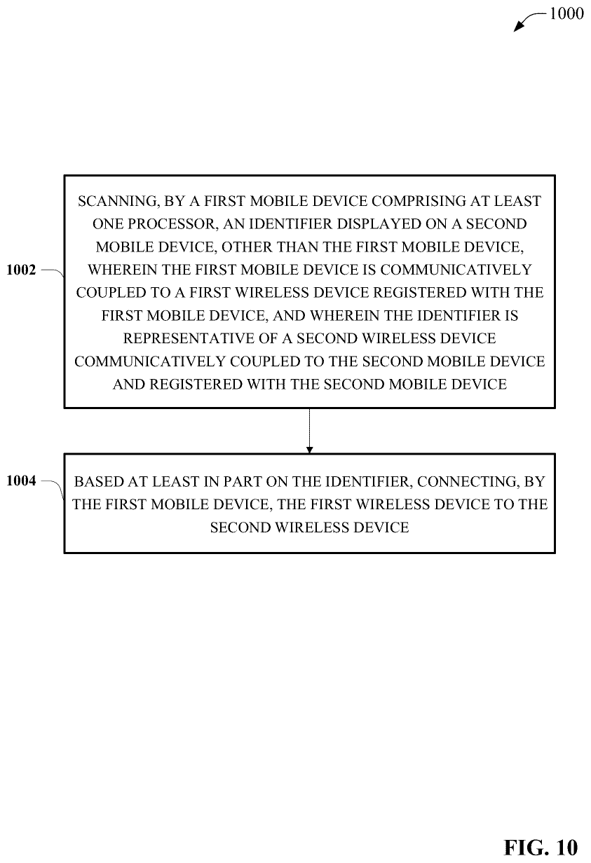

FIG. 10 illustrates a block flow diagram for a process 1000 associated with connecting multiple wireless devices for full duplex voice communication over a wireless network in accordance with one or more embodiments described herein. At 1002, the process 1000 can comprise scanning, by a first mobile device (e.g., mobile device 112) comprising at least one processor (e.g., via a capture component 202), an identifier displayed on a second mobile device (e.g., mobile device 116), other than the first mobile device (e.g., mobile device 112), wherein the first mobile device (e.g., mobile device 112) is communicatively coupled to a first wireless device (e.g., WD 114) registered with the first mobile device (e.g., mobile device 112), and wherein the identifier is representative of a second wireless device (e.g., WD 118) communicatively coupled to the second mobile device (e.g., mobile device 116) and registered with the second mobile device (e.g., mobile device 116). At 1004, the process 1000 can comprise, based at least in part on the identifier, connecting (e.g., via the communication component 204), by the first mobile device (e.g., mobile device 112), the first wireless device (e.g., WD 114) to the second wireless device (e.g., WD 118).

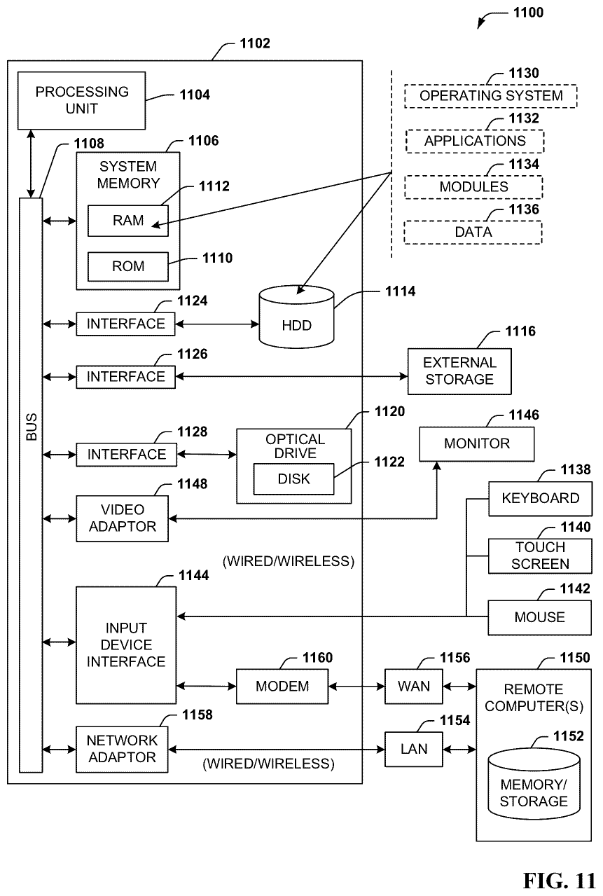

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a disk 1122, such as a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

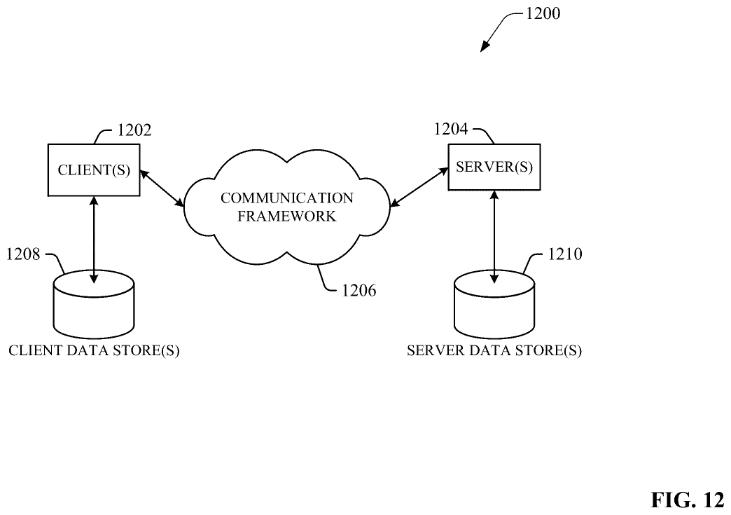

Referring now to FIG. 12, there is illustrated a schematic block diagram of a computing environment 1200 in accordance with this specification. The system 1200 includes one or more client(s) 1202, (e.g., computers, smart phones, tablets, cameras, PDA's). The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware or hardware in combination with software (e.g., threads, processes, computing devices). The servers 1204 can house threads to perform transformations of media items by employing aspects of this disclosure, for example. One possible communication between a client 1202 and a server 1204 can be in the form of a data packet adapted to be transmitted between two or more computer processes wherein data packets may include coded analyzed headspaces and/or input. The data packet can include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

In one exemplary implementation, a client 1202 can transfer an encoded file, (e.g., encoded media item), to server 1204. Server 1204 can store the file, decode the file, or transmit the file to another client 1202. It is noted that a client 1202 can also transfer uncompressed files to a server 1204 and server 1204 can compress the file and/or transform the file in accordance with this disclosure. Likewise, server 1204 can encode information and transmit the information via communication framework 1206 to one or more clients 1202.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a first mobile device comprising a mobile application installed and executing thereon, at least one processor, and at least one memory that stores executable instructions that, when executed by the at least one processor, facilitate performance of operations, comprising:
scanning an identifier displayed via a second mobile device, other than the first mobile device, wherein the first mobile device is communicatively coupled to a first wireless device registered with the first mobile device, and wherein the identifier is representative of a second wireless device communicatively coupled to the second mobile device and registered with the second mobile device; and
using the identifier, wirelessly connecting the first wireless device to the second wireless device.

2. The system of claim 1, wherein the identifier is a first identifier, and wherein the operations further comprise:
scanning a second identifier displayed via a third mobile device, other than the first mobile device and other than the second mobile device, wherein the second identifier is representative of a third wireless device communicatively coupled to the third mobile device and registered with the third mobile device; and
using the second identifier, wirelessly connecting the third wireless device to the second wireless device and to the first wireless device.

3. The system of claim 2, wherein the wirelessly connecting of the third wireless device to the second wireless device and to the first wireless device is performed in response to a determination that no additional wireless devices other than the second wireless device and the third wireless device are to be connected.

4. The system of claim 1, wherein the wirelessly connecting of the second wireless device to the first wireless device is performed in response to a determination that no additional wireless devices other than the second wireless device are to be wirelessly connected.

5. The system of claim 1, wherein the first wireless device comprises a wireless voice communication device.

6. The system of claim 5, wherein the wireless voice communication device comprises a helmet communicator configured to transmit, receive, record, and render voice and sound signals.

7. The system of claim 1, wherein the identifier is representative of a medium access control address of the second wireless device.

8. The system of claim 1, wherein the identifier comprises a quick response (QR) code.

9. The system of claim 1, wherein the first wireless device and the second wireless device are among a group of wireless devices to be wirelessly connected to each other via the first mobile device.

10. The system of claim 1, wherein the wirelessly connecting of the second wireless device to the first wireless device is performed in response to receiving an instruction to wirelessly connect the second wireless device to the first wireless device.

11. A non-transitory machine-readable medium, comprising executable instructions that, when executed by at least one processor, facilitate performance of operations, comprising:
capturing an identifier displayed via a second mobile device, other than a first mobile device, wherein the first mobile device is communicatively coupled to a first wireless device registered with the first mobile device, and wherein the identifier is representative of a second wireless device communicatively coupled to the second mobile device and registered with the second mobile device; and
using the identifier, communicatively coupling the first wireless device to the second wireless device.

12. The non-transitory machine-readable medium of claim 11, wherein the communicatively coupling of the second wireless device to the first wireless device is performed in response to the capturing of the identifier displayed via the second mobile device.

13. The non-transitory machine-readable medium of claim 11, wherein the operations further comprise:
capturing another identifier, other than the identifier, displayed via a third mobile device, other than the first mobile device and other than the second mobile device, wherein the other identifier is representative of a third wireless device communicatively coupled to the third mobile device and registered with the third mobile device; and
using the other identifier, communicatively coupling the third wireless device to the second wireless device and to the first wireless device.

14. The non-transitory machine-readable medium of claim 13, wherein the communicatively coupling of the third wireless device to the first wireless device and to the second wireless device is performed in response to the capturing of the identifier displayed via the third mobile device.

15. The non-transitory machine-readable medium of claim 11, wherein the first wireless device comprises a wireless voice communication device.

16. The non-transitory machine-readable medium of claim 15, wherein the wireless voice communication device comprises a helmet communicator.

17. The non-transitory machine-readable medium of claim 11, wherein the identifier is representative of a medium access control address of the second wireless device.

18. A method, comprising:
scanning, by a first mobile device comprising at least one processor, an identifier displayed on a second mobile device, other than the first mobile device, wherein the first mobile device is communicatively coupled to a first wireless device registered with the first mobile device, and wherein the identifier is representative of a second wireless device communicatively coupled to the second mobile device and registered with the second mobile device; and
based at least in part on the identifier, connecting, by the first mobile device, the first wireless device to the second wireless device.

19. The method of claim 18, wherein the identifier comprises a quick response (QR) code.

20. The method of claim 18, wherein the first wireless device and the second wireless device are among a group of wireless devices designated to be communicatively coupled to each other via the first mobile device.
